(19) United States
(12) Patent Application Publication
(10) Pub. No.: US 2012/0303368 A1
(43) Pub. Date: Nov. 29, 2012

(54) NUMBER-ASSISTANT VOICE INPUT SYSTEM, NUMBER-ASSISTANT VOICE INPUT METHOD FOR VOICE INPUT SYSTEM AND NUMBER-ASSISTANT VOICE CORRECTING METHOD FOR VOICE INPUT SYSTEM

(76) Inventor: Ting MA, Shanghai (CN)

(21) Appl. No.: 13/117,491

(22) Filed: May 27, 2011

(51) Int. Cl. G10L 15/26

(52) U.S. Cl. 704/235; 704/E15.043

(57) ABSTRACT

The present invention discloses a number-assistant voice input system, a number-assistant voice input method for a voice input system and a number-assistant voice correcting method for a voice input system, which apply software to drive a voice input system of an electronic device to provide a voice input logic circuit module. The voice input logic circuit module defines the pronunciation of numbers 1 to 26 as the paths to respectively input letters A to Z in the voice input system and allows users to selectively input or correct a letter by reading a number from 1 to 26 instead of a letter from A to Z.

### BACKGROUND OF THE INVENTION

1. Field of the Invention

The present invention relates to a number-assistant voice input system, a number-assistant voice input method, and a number-assistant voice correcting method for a voice input system and more particularly to an application of a technical measure of selectively using the pronunciation of numbers to substitute the pronunciation of letters for a voice input.

2. Description of the Related Art

As science and technology advance, various different electronic devices with a computing or processing system such as desktop or portable computers, smart phones, and personal digital assistants (PDA) are introduced in our daily life. To improve the convenience of using these electronic devices, engineers and manufacturers keep on developing new input technologies, and the assistant voice input method is one of the convenient ones, not only avoids the trouble of the manual control or write operations, but also assists some users such as patients or elderly who cannot operate freely by hands.

However, the present existing voice input technologies become matured gradually, but the accuracy of voice recognition is still a technical bottleneck, and an accuracy of 100% cannot be achieved yet. Therefore, technical measures taken for improving the conventional voice input methods by increasing the input accuracy of electronic equipments of this sort, and quickly correcting any voice recognition error to shorten the delay caused by the input errors, so as to prevent the repeated trials for making an accurate recognition or the need of manually controlling the input. In view of the difficulty of improving the input accuracy, the inventor of the present invention designed a number-assistant voice input system, a number-assistant voice input method for a voice input system and a number-assistant voice correcting method for a voice input system to overcome the shortcomings of the prior art and improve the industrial applications.

### SUMMARY OF THE INVENTION

It is a primary objective of the invention to overcome the shortcomings of the prior art by providing a number-assistant voice input system, a number-assistant voice input method for a voice input system and a number-assistant voice correcting method for a voice input system in accordance with the present invention.

To achieve the foregoing objectives, the present invention provides a number-assistant voice input system, comprising:

a voice input unit, being a voice receiver provided for a user to input a voice; a display unit, driven and controlled for displaying information to a user by a screen; and

a logic processing unit, including at least one processor and a logic circuit of a storage device, and electrically coupled to the voice input unit and the display unit, and driven by software for providing a voice input logic circuit;

thereby, the voice input logic circuit allows the user to input a voice through the voice input unit, and read letters one by one for a single-word spelling input, and when the user reads the letters, a voice recognition takes place to select the closest letters for a permutation display on the display unit, and the voice input logic circuit defines the pronunciation of numbers 1 to 26 in correspondence with 26 English letters from A to Z respectively, so as to allow the user to selectively use the pronunciation of numbers 1 to 26 to substitute the pronunciation of A to Z for an input.

Wherein, the voice input unit is a microphone, and the display unit is a liquid crystal display.

The present invention further provides another number-assistant voice input system, comprising:

a voice input unit, being a voice receiver, provided for a user to enter a voice;

a display unit, driven and controlled for displaying information to the user by a screen;

a logic processing unit, including at least one processor and a logic circuit of a storage device, and electrically coupled to the voice input unit and the display unit, and driven by software to provide a voice input logic circuit and a voice input correcting logic circuit;

wherein, the voice input logic circuit defines the pronunciation of numbers 1 to 26 corresponding to the 26 English letters of A to Z, and allows the user to selectively use the pronunciation of numbers 1 to 26 to substitute the pronunciation of A to Z for an input, and the voice input logic circuit allows the user to selectively input through the voice input unit, and performs an input by reading the letters one by one for spelling a word, and when the user reads the letters for a voice recognition, the closest letter is selected for a permutation display on the display unit, or the voice input logic circuit selectively allows the user to pronounce a single word, and a voice recognition takes place and the best matched corresponding single word is displayed on the display unit;

thereby, the voice input correcting logic circuit provides a plurality of voice instructions used making a correction and provided for the user to correct a wrong letter inputted by the voice input method.

Wherein, the voice input correcting logic circuit divides a string to be corrected into a block by a plurality of consecutive words. Moreover, the voice input correcting logic circuit provides four correcting voice instructions including the instructions of adding a letter, deleting a letter, modifying a letter, and correcting a block corresponding to four correction modes respectively. The user is allowed to speak out a correcting voice instruction in a correction mode, so as to correct the string to be corrected. The four correction modes correspond to the four different voices respectively. The user is allowed through a setup to have a voice including one of the four correction modes in a specific voice instruction stream, specify a voice operand of a block corresponding to the correcting letter, and specify a voice operand corresponding to a letter sequence as parameters to specify the correction of a letter at a specific position in a string.

Wherein, the voice input correcting logic circuit divides the string to be corrected into a block by three consecutive words, and the voice input unit is a microphone, and the display unit is a liquid crystal display.

The present invention further provides a number-assistant voice input method for a voice input system, and the method is applied to a voice input system of an electronic device driven by software to provide a voice input logic circuit. The voice input logic circuit is used for defining the pronunciation of numbers 1 to 26 corresponding to 26 English letters from A to Z respectively, and allowing a user to selectively input a voice input by the pronunciation of numbers 1 to 26 instead of the pronunciation of letters from A to Z.

The present invention further provides a number-assistant voice correcting method for a voice input system, wherein the voice input system of an electronic device is driven by software to provide a voice input correcting logic circuit. The voice input correcting logic circuit provides a plurality of voice instructions used for making a correction and provided for the user to correct a wrong letter inputted by the voice input method at an early stage of recognizing the voice input.

Wherein, the voice input correcting logic circuit sets a string to be corrected as a block by a plurality of consecutive words. Moreover, the voice input correcting logic circuit provides four correction modes for correcting a voice instruction such as adding a letter, deleting a letter, modifying a letter, and correcting a block, so that a user can speak out the correction voice instruction with a corresponding correction mode to correct the string to be corrected. The four correction modes correspond to four different voices respectively. The voice input correcting logic circuit through a setup further allows the user to include one of the four correction modes in a specific voice instruction stream, specify a voice operand corresponding to a block of the correcting letter, and specify a voice operand corresponding to the correcting alphabetical sequence as a parameter. Accordingly, the user can specify the letter of a specific block and a specific alphabetical sequence of the string to be corrected for a correction with one of the four correction modes.

As to the design of the present invention, a high recognition characteristic of a user's voice input is enhanced, so that the issue of similar and/or ambiguous pronunciations of the English letters can be avoided, and the accuracy and smoothness of the voice input can be improved. Once the voice system has made a recognition error of a string, the user can directly give a quick voice instruction to add, delete or modify a letter to be corrected in the string. The present invention definitely can reduce the time of correcting letters due to the wrong voice recognition significantly to prevent the repeated trials for making an accurate recognition or the need of manually controlling the input.

### BRIEF DESCRIPTION OF THE DRAWINGS

FIG. 1 is a schematic block diagram of a number-assistant voice input system of the present invention;

FIG. 2 is a schematic view of a number-assistant voice input system, a number-assistant voice input method for a voice input system, and a number-assistant voice correcting method for a voice input system in accordance with a preferred embodiment of the present invention;

FIGS. 3 to 6 show four ways of making corrections in correspondence with FIG. 3 and accordance with the present invention.

### DETAILED DESCRIPTION OF THE PREFERRED EMBODIMENTS

To make it easier for our examiner to understand the technical contents of the present invention, preferred embodiments together with related drawings are used for the detailed description of the present invention as follows. It is noteworthy to point out that the drawings are provided for the purpose of illustrating the present invention only, and they are not necessarily drawn in actual size or in proportion, and thus they are not intended for limiting the scope of the present invention.

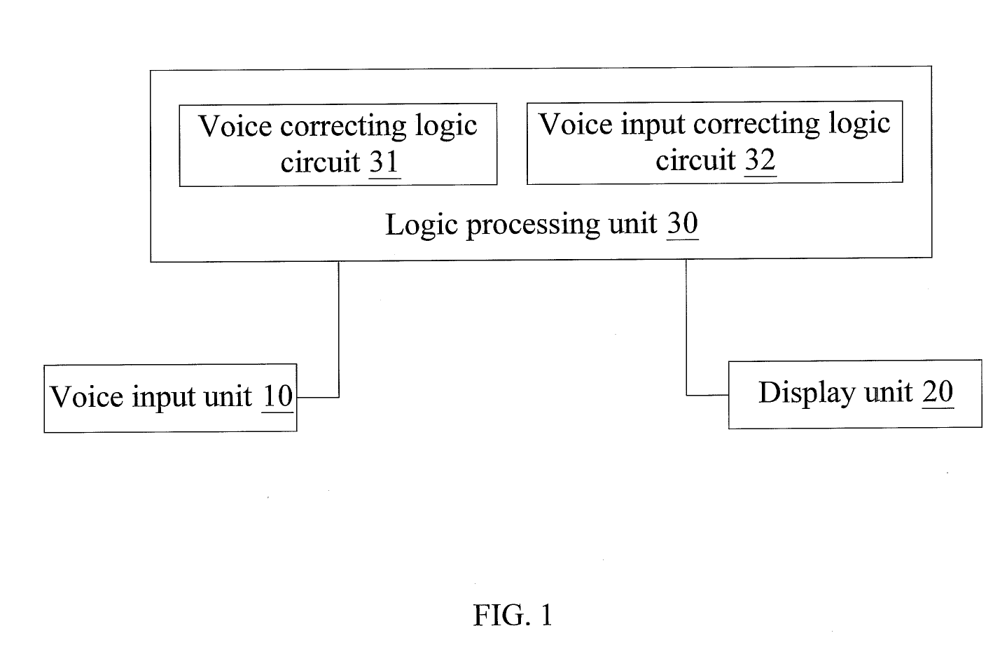

With reference to FIG. 1 for a schematic block diagram of a number-assistant voice input system of the present invention, the number-assistant voice input system is applied to various different smart electronic devices such as computers, smart phones or personal digital assistants (PDA) for assisting the voice input accuracy and reducing the complicated procedure for correcting a wrong recognition. A preferred embodiment of the number-assistant voice input system comprises a voice input unit 10, a display unit 20 and a logic processing unit 30.

The voice input unit 10 can be voice receiver such as a microphone provided for a user to input a voice.

The display unit 20 is driven and controlled to display information on a screen for the user, and the display unit 20 can be a liquid crystal display.

The logic processing unit 30 includes at least one processor and a logic circuit of a storage device, and the logic processing unit 30 is electrically coupled to the voice input unit 10 and the display unit 20, and driven by software to provide at least one voice input logic circuit 31 and a voice input correcting logic circuit 32.

Wherein, the voice input logic circuit 31 is provided for the user to input a voice through the voice input unit 10. For example, the user is allowed to read letters one by one for a single-word spelling input, and a voice recognition takes place after the user reads the letters, and the closest letter is selected for a permutation display on the display unit 20. In addition the voice input logic circuit defines the pronunciation of 26 numbers from 1 (one) to 26 (twenty six) corresponding to the 26 English letters from A to Z respectively, so as to allow the user to selectively input the pronunciation of 26 numbers from 1 (one) to 26 (twenty six) instead of the pronunciation of letters from A to Z. For example, if the user wants to input a string of A-B-C, the user can read 1-B-C or A-2-C or A-B-3 to avoid specific letters that cannot be recognized easily (such as T and C, or A, S and X, or A and AA, or PE and P, etc), such similar or ambiguous pronunciation may affect the smoothness of the input.

Wherein, the hit rate of recognizing the voices for the numbers from 1 to 26 approaches 100%, unlike the pronunciation of the English letters having similar and ambiguous pronunciations.

In addition, the voice input logic circuit 31 is provided for the user to use the voice input method, or selectively allow the user to pronounce a single word, and then a voice recognition takes place, and finally the best matched corresponding single word is displayed on the display unit 20.

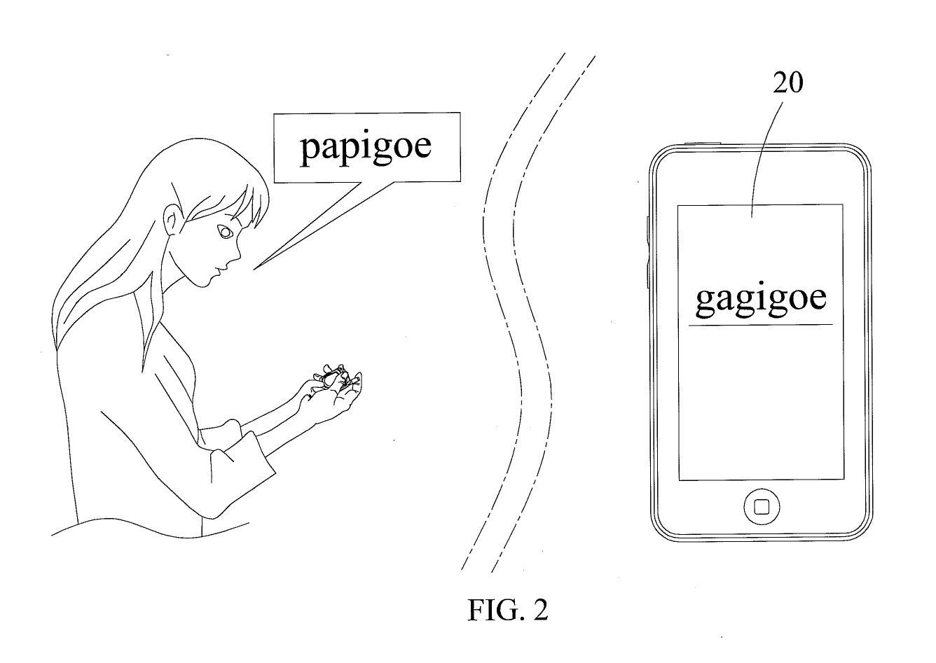

In FIG. 2, the voice input correcting logic circuit 32 can provide a plurality of correcting voice instructions for the user to correct a wrong letter recognized in the voice input. For example, if the user wants to input a string “papigoe” but the string is mistaken as “gagigoe”, the voice input correcting logic circuit 32 will divide the string to be corrected into a block by a plurality of consecutive words, such as three words as a block, or “papigoe” is divided into three blocks, which are pap-igo-e. Similarly, 2 words, 4 words or any other appropriate number of words can be used as a block in the present invention.

Then, the voice input correcting logic circuit 32 provides correcting voice instructions of at least four correction modes to allow the user to speak out the correcting voice instruction of the correction mode in order to correct the string to be corrected. The four correction modes include adding a letter, deleting a letter, modifying a letter, and correcting a block, and the four correction modes correspond to four different voices respectively, such as adding a letter corresponds to the voice of “ADD”, deleting a letter corresponds to the voice of “DELETE”, modifying a letter corresponds to the voice of “MODIFY”, and correcting a block corresponds to the voice of “CORRECT”. With a user setup, the user is allowed to have a voice including one of the four correction modes in a specific voice instruction stream, specify a voice operand of a block corresponding to the correcting letter, and specify a voice operand corresponding to a letter sequence as parameters to specify the correction of a letter at a specific block and a letter with a specific sequence for the correction of four correction modes.

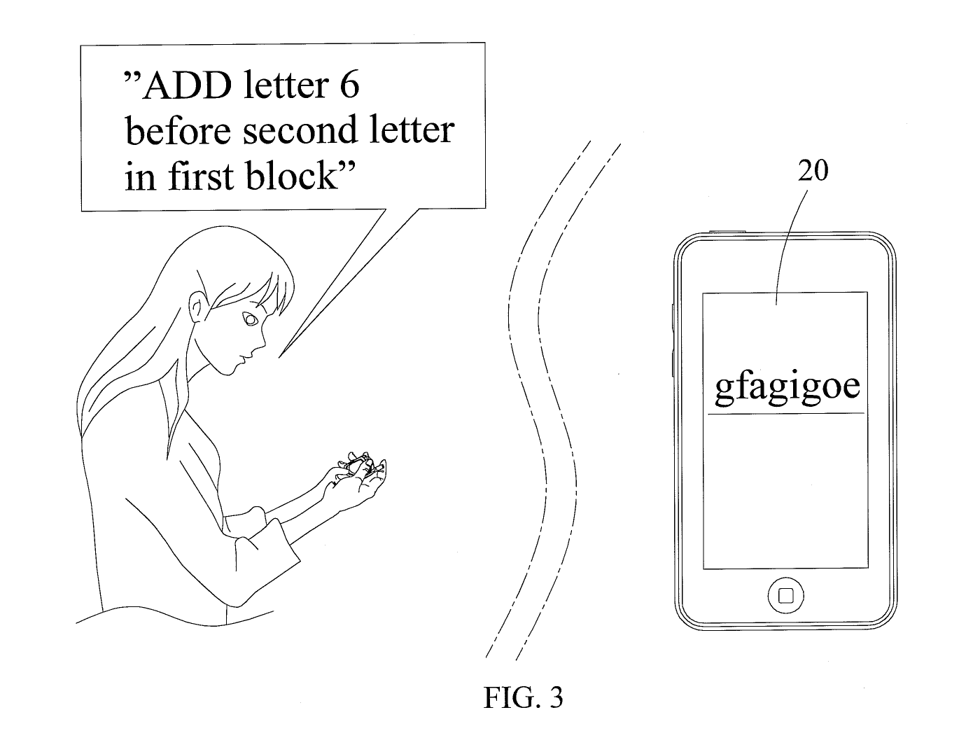

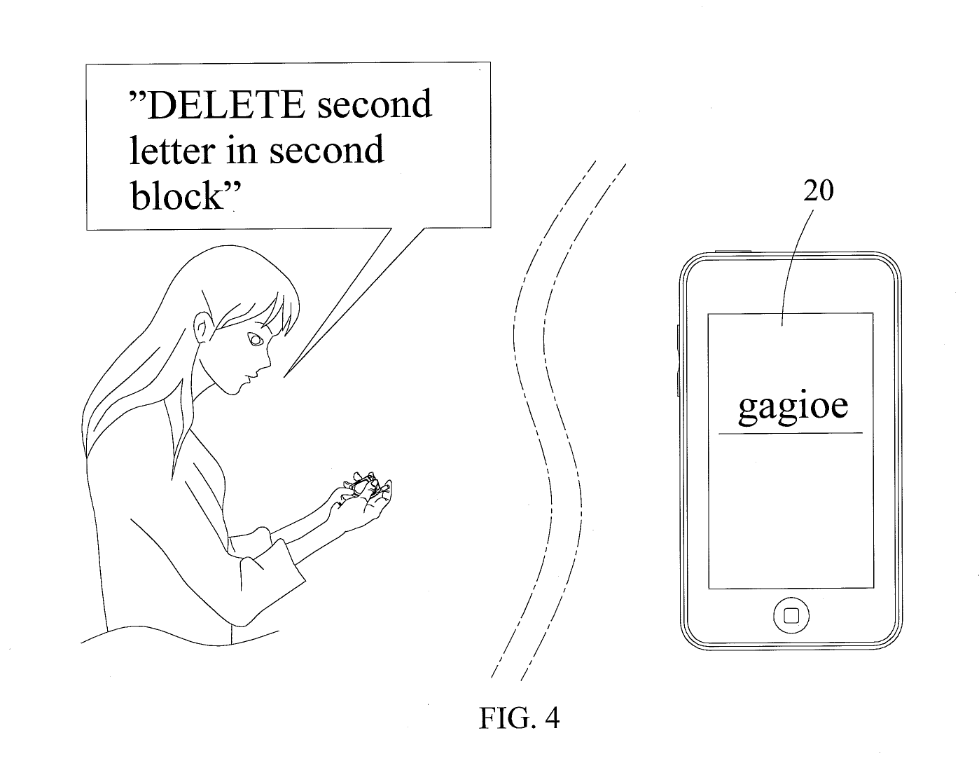

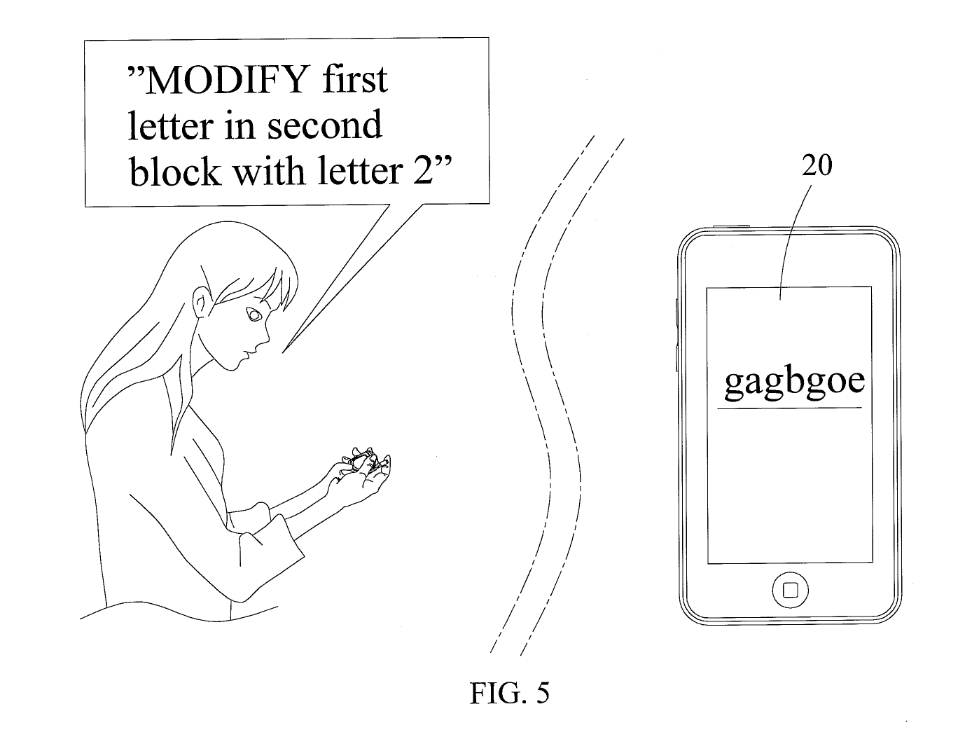

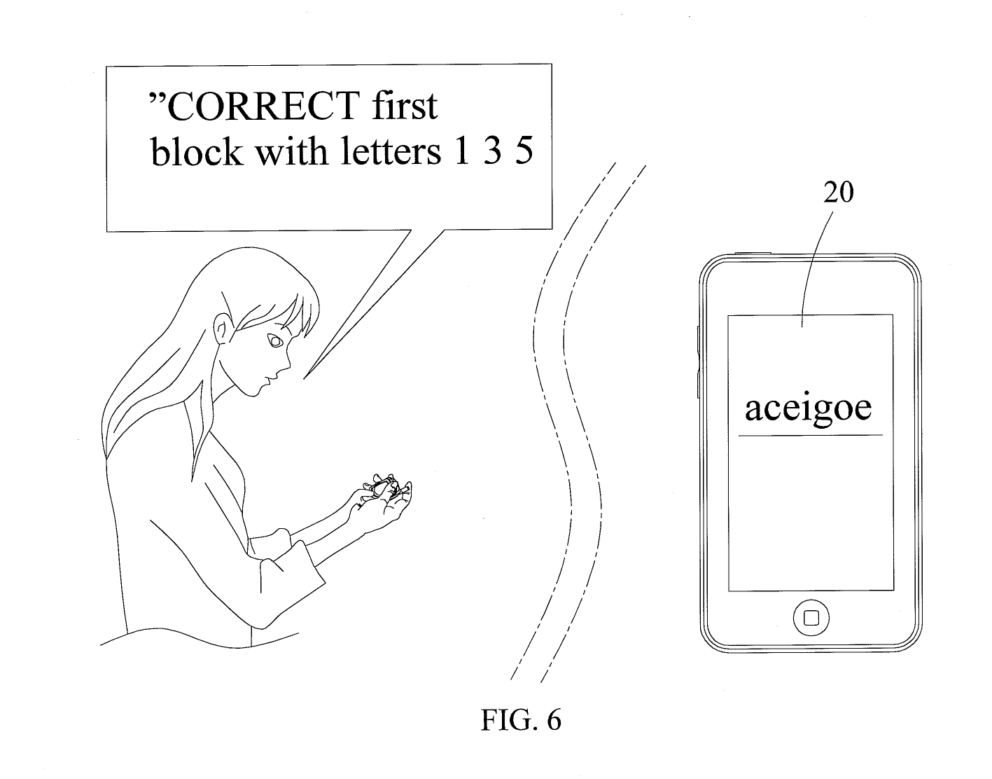

With reference to FIGS. 3 to 6, if the user says, “ADD letter 6 before second letter in first block”, then the voice input correcting logic circuit 32 will be driven to add a letter f in front of the second letter of the first block.

If the user says, “DELETE second letter in second block”, then the voice input correcting logic circuit 32 will be driven to delete the second letter in the second block.

If the user says, “MODIFY first letter in second block with letter 2”, then the voice input correcting logic circuit 32 will be driven to modify the first letter of the second block to the letter b; If the user says, “CORRECT first block with letters 1 3 5”, then the voice input correcting logic circuit 32 will be driven to replace the letters in the first block with ace. However, the compilation of the aforementioned voice instructions of the four modes is provided for the illustration purpose only, and any equivalent or appropriate arrangement can be made in this invention.

The present invention further provides a number-assistant voice input method for a voice input system, and the method is applied in a voice input system of an electronic device and driven by software to provide a voice input logic circuit. The voice input logic circuit is used for defining the pronunciation of numbers 1 to 26 corresponding to 26 English letters from A to Z, and allowing a user to selectively replace the pronunciation of letters from A to Z with the pronunciation of numbers 1 to 26 for a voice input.

The present invention further provides a number-assistant voice correcting method for a voice input system, and the method is applied in a voice input system of an electronic device and driven by software to provide a voice correcting input logic circuit 32. The voice input correcting logic circuit 32 provides a plurality of correcting voice instructions for the user to use a voice method to correct a wrong recognized letter of a voice input at the early stage when the user finds the wrong recognition of the voice input. The voice input correcting logic circuit 32 divides the string to be corrected into a block by a plurality of successive words, and then the voice input correcting logic circuit 32 provides correcting voice instructions of at least four correction modes to allow the user to speak out the correcting voice instruction of the corresponding correction mode to correct the string to be corrected.

The four correction modes include adding a letter, deleting a letter, modifying a letter and correcting a block, and the four correction modes correspond to the four different voices respectively, such as adding a letter corresponds to the voice of “ADD”, deleting a letter corresponds to the voice of “DELETE”, modifying a letter corresponds to the voice of “MODIFY”, and correcting a block corresponds to the voice of “CORRECT”. With a user setup, the user is allowed to have a voice including one of the four correction modes in a specific voice instruction stream, specify a voice operand of a block corresponding to the correcting letter, and specify a voice operand corresponding to a correcting letter sequence as parameters to specify the correction of a letter at a specific position in a string.

With the skillful design of the present invention, a high recognition characteristic of a user's voice input is enhanced, so that the issue of similar and/or ambiguous pronunciations of the English letters can be avoided, and the accuracy and smoothness of the voice input can be improved. Once the voice system has made a recognition error of a string, the user can directly give a quick voice instruction to add, delete or modify a letter to be corrected in the string. The present invention definitely can reduce the time of correcting letters due to the wrong voice recognition significantly to prevent the repeated trials for making an accurate recognition or the need of manually controlling the input. Obviously, the present invention improves over the prior art.

While the invention has been described by device of specific embodiments, numerous modifications and variations could be made thereto by those generally skilled in the art without departing from the scope and spirit of the invention set forth in the claims.

What is claimed is:

1. A number-assistant voice input system, comprising:
a voice input unit, being a voice receiver provided for a user to input a voice;
a display unit, driven and controlled for displaying information to a user by a screen; and
a logic processing unit, including at least one processor and a logic circuit of a storage device, and electrically coupled to the voice input unit and the display unit, and driven by software for providing a voice input logic circuit;
wherein, the voice input logic circuit allows the user to input a voice through the voice input unit, and read letters one by one for a single-word spelling input, and when the user reads the letters, a voice recognition takes place to select the closest letters for a permutation display on the display unit, and the voice input logic circuit defines the pronunciation of numbers 1 to 26 in correspondence with 26 English letters from A to Z respectively, so as to allow the user to selectively use the pronunciation of numbers 1 to 26 to substitute for the pronunciation of A to Z for an input.

2. The number-assistant voice input system of claim 1, wherein the voice input unit is a microphone.

3. The number-assistant voice input system of claim 1, wherein the display unit is a liquid crystal display.

4. A number-assistant voice input system, comprising:
a voice input unit, being a voice receiver, provided for a user to enter a voice;
a display unit, driven and controlled for displaying information to the user by a screen; and
a logic processing unit, including at least one processor and a logic circuit of a storage device, and electrically coupled to the voice input unit and the display unit, and driven by software to provide a voice input logic circuit and a voice input correcting logic circuit;
wherein the voice input logic circuit defines the pronunciation of numbers 1 to 26 corresponding to the 26 English letters of A to Z, and allows the user to selectively use the pronunciation of numbers 1 to 26 to substitute for the pronunciation of A to Z for an input, and the voice input logic circuit allows the user to selectively input through the voice input unit, and performs an input by reading the letters one by one for spelling a word, and when the user reads the letters for a voice recognition, the closest letter is selected for a permutation display on the display unit, or the voice input logic circuit selectively allows the user to pronounce a single word, and a voice recognition takes place and the best matched corresponding single word is displayed on the display unit;
wherein, the voice input correcting logic circuit provides a plurality of voice instructions used for making a correction and provided for the user to correct a wrong letter inputted by the voice input method.

5. The number-assistant voice input system of claim 4, wherein the voice input correcting logic circuit divides a string to be corrected into a block by a plurality of consecutive words, and then the voice input correcting logic circuit provides four correcting voice instructions including the instructions of adding a letter, deleting a letter, modifying a letter, and correcting a block corresponding to four correction modes respectively to allow the user to speak out a correcting voice instruction in a correction mode, so as to correct the string to be corrected, and the four correction modes are corresponsive to the four different voices respectively, and the user is allowed through a setup to have a voice including one of the four correction modes in a specific voice instruction stream, specify a voice operand of a block corresponding to the correcting letter, and specify a voice operand corresponding to a letter sequence as parameters to specify the correction of a letter at a specific position in a string.

6. The number-assistant voice input system of claim 5, wherein the voice input correcting logic circuit uses three consecutive words to divide a string to be corrected into a block.

7. The number-assistant voice input system of claim 5, wherein the voice input unit is a microphone, and the display unit is a liquid crystal display.

8. A number-assistant voice input method for a voice input system, applied in a voice input system of an electronic device and driven by software to provide a voice input logic circuit, for defining the pronunciation of numbers 1 to 26 corresponding to 26 English letters from A to Z, and allowing a user to selectively replace the pronunciation of letters from A to Z with the pronunciation of numbers 1 to 26 for a voice input.

9. A number-assistant voice correcting method for a voice input system, applied in a voice input system of an electronic device and driven by software to provide a voice input correcting logic circuit, and the voice input correcting logic circuit providing a plurality of correcting voice instructions for the user to use a voice method to correct a wrong recognized letter of a voice input at the early stage when the user finds the wrong recognition of the voice input.

10. The number-assistant voice correcting method for a voice input system as recited in claim 9, wherein the voice input correcting logic circuit divides a string to be corrected into a block by a plurality of consecutive words, and then the voice input correcting logic circuit provides four correcting voice instructions including the instructions of adding a letter, deleting a letter, modifying a letter, and correcting a block corresponding to four correction modes respectively to allow the user to speak out a correcting voice instruction in a correction mode, so as to correct the string to be corrected, and the four correction modes correspond to the four different voices respectively, and the user is allowed through a setup to have a voice including one of the four correction modes in a specific voice instruction stream, specify a voice operand of a block corresponding to the correcting letter, and specify a voice operand corresponding to a letter sequence as parameters to specify the correction of a letter at a specific position in a string.
